(19) United States
(12) Patent Application Publication
(10) Pub. No.: US 2018/0109930 A1
(43) Pub. Date: Apr. 19, 2018

(54) ELECTRONIC DEVICE AND METHOD FOR CONTROLLING INDUSTRIAL COMMUNICATION DEVICE, AND INDUSTRIAL COMMUNICATION DEVICE THEREOF

(71) Applicant: KMW INC., Hwaseong-si (KR)

(72) Inventors: Jae-Sung KIM, Yongin-si (KR); Young-Jun KIM, Seongnam-si (KR); Ji-Man KIM, Hwaseong-si (KR); Gun-Sang LEE, Gunpo-si (KR); Young-Uk SON, Hwaseong-si (KR); Jae-Won LEE, Suwon-si (KR)

(73) Assignee: KMW INC.

(21) Appl. No.: 15/844,446

(22) Filed: Dec. 15, 2017

Related U.S. Application Data
(63) Continuation of application No. PCT/KR2016/006293, filed on Jun. 14, 2016.

(30) Foreign Application Priority Data
Jun. 15, 2015 (KR) 10-2015-0084424

(51) Int. Cl. H04W 4/08; H04B 5/00; H04L 12/58; H04W 4/12

(52) U.S. Cl. CPC H04W 4/08; H04W 4/22; H04B 5/0006; H04M 1/7255; H04W 4/12; H04L 51/16; H04L 51/046

(57) ABSTRACT

An electronic device for controlling an industrial communication device may include: a near field communication module; a main communication module; and a control unit configured to confirm one or more contacts connected to a conversation group of a messenger application when a voice signal corresponding to a first voice is received from an industrial communication device paired through the near field communication module, and transmit a voice message corresponding to the first voice to the corresponding device or devices of the confirmed contact or contacts using the main communication module.

### CROSS-REFERENCE TO RELATED APPLICATION

This application is a Continuation of International Application No. PCT/KR2016/006293, filed on Jun. 14, 2016, which claims the benefit of and priority to Korean Patent Application No. 10-2015-0084424, filed on Jun. 15, 2015, the content of which are herein incorporated by reference in their entirety.

### TECHNICAL FIELD

The present invention relates to an electronic device and method for controlling an industrial communication device, and an industrial communication device thereof.

### BACKGROUND ART

With the development of industrial technology, disaster sites or industrial sites such as a construction site, ship yard and machinery plant have become bigger and more complex. Therefore, for the improvement in safety of workers in an industrial site or disaster site and the increase in specialty and efficiency of operation, the workers should wear protection gears such as a helmet, belt and gloves, and necessarily carry communication equipment for cooperation work with a central control center or other workers.

Conventionally, workers could wear a protection gear such as a helmet to which a communication device such as a radio receiver is coupled, in order to wirelessly communicate with other workers through the communication devices.

However, the conventional protection gear to which the communication device such as a radio receiver is coupled could simply transmit and/or receive voices between a sender and receiver, and the quality of radio signals might not be guaranteed depending on a distance between the users.

### DISCLOSURE

### Technical Problem

An object of the present invention to provide an electronic device and method for controlling an industrial communication device capable of transmitting and/or receiving a high-quality voice signal between users wearing protection gears without a limitation by distance, and an industrial communication device thereof.

Another object of the present invention to provide an electronic device and method for controlling an industrial communication device having a radio communication function and a near field communication function, and an industrial communication device thereof.

Still another object of the present invention to provide an electronic device and method for controlling an industrial communication to communicate using an electronic device which is selectively connected to radio communication or a communication device of a protection gear, during communication between users wearing protection gears.

Yet another object of the present invention to provide an electronic device and method through which a user wearing a protection gear can transmit a voice and/or text signal to users connected to a conversation group of a messenger application, using the messenger application installed in an electronic device connected to a communication device of the protection gear through near field communication.

### Technical Solution

In one general aspect, an electronic device for controlling an industrial communication device may include: a near field communication module; a main communication module; and a control unit configured to confirm one or more contacts connected to a conversation group of a messenger application when a voice signal corresponding to a first voice is received from an industrial communication device paired through the near field communication module, and transmit a voice message corresponding to the first voice to the corresponding device or devices of the confirmed contact or contacts using the main communication module.

In another general aspect, an industrial communication device may include: a near field communication module; a radio communication module configured to communicate FRS (Family Radio Service) signals; a voice input unit; an input module; and a control unit configured to decide whether to execute a radio communication function or near field communication function, according to a user manipulation inputted through the input module, and transmit a voice signal corresponding to a first voice to the outside through the radio communication module when the first voice is inputted through the voice input unit after the execution of the radio communication function was decided, or transmit a voice signal corresponding to a second voice to an electronic device paired through the near field communication module when the second voice is inputted through the voice input unit after the execution of the near field communication function was decided.

In still another general aspect, a method for controlling an industrial communication may include: confirming one or more contact connected to a conversation group of a messenger application when receiving a signal corresponding to a first voice from an industrial communication device paired through near field communication; and transmitting voice data corresponding to the first voice to the corresponding device or devices of the confirmed contact or contacts through wireless LAN communication.

In yet another general aspect, a method for controlling an industrial communication device may include: deciding, by the industrial communication device, whether to execute a radio communication function or near field communication function, according to a user manipulation; transmitting, by the industrial communication device, a voice signal corresponding to a first voice to the outside through a designated radio channel using radio communication, when the first voice is inputted through a voice input unit of the industrial communication device after the execution of the radio communication function was decided; transmitting, by the industrial communication device, a voice signal corresponding to a second voice to an electronic device paired through near field communication, when the second voice is inputted through the voice input unit of the industrial communication device after the execution of the near field communication function was decided; outputting, by the industrial communication device, a third voice through a sound output unit of the industrial communication device when receiving a signal corresponding to the third voice from the electronic device through the near field communication; and outputting, by the industrial communication device, a fourth voice through the sound output unit of the industrial communication device when receiving a signal corresponding to the fourth voice from another industrial communication device through the radio communication.

### Advantageous Effects

As described above, when the electronic device and method for controlling an industrial communication device and the industrial communication device are used, high-quality voice signals can be transmitted and/or received between users wearing protection gears without a limitation by distance. Furthermore, the industrial communication device may have the radio function and the near field communication function, and the users wearing protection gears can communicate with each other through radio communication or an electronic device connected to communication devices of the protection gears through near field communication. Moreover, a user wearing a protection gear can transmit a voice and/or text signal to users connected to a messenger application, using the messenger application installed in an electronic device connected to a communication device of the protection gear through near field communication.

### DESCRIPTION OF DRAWINGS

FIG. 1 is a block diagram of an industrial communication system according to an embodiment of the present invention.

FIG. 2 illustrates an industrial communication device according to an embodiment of the present invention.

FIGS. 3A and 3B are flowcharts illustrating an operation of the industrial communication system according to the embodiment of the present invention.

FIG. 4 illustrates visual effects displayed when a voice signal is received according to an embodiment of the present invention.

FIG. 5 is a flowchart an operation of an industrial communication system according to another embodiment of the present invention.

FIG. 6 illustrates screens displayed on an electronic device when a message corresponding to an accident alarm is received according to an embodiment of the present invention.

FIG. 7 illustrates screens displayed on an electronic device when a message corresponding to an accident alarm is received according to another embodiment of the present invention.

FIG. 8 is a flowchart illustrating an operation of an electronic device for controlling an industrial communication device according to an embodiment of the present invention.

FIG. 9 is a flowchart illustrating an operation of an electronic device for controlling an industrial communication device according to another embodiment of the present invention.

FIG. 10 is a flowchart illustrating an operation of an industrial communication device according to an embodiment of the present invention.

FIG. 11 is a flowchart illustrating an operation of an industrial communication device according to another embodiment of the present invention.

FIG. 12 illustrates a screen which is displayed when a user installs a messenger application and joins a messenger service according to an embodiment of the present invention.

FIG. 13 illustrates a screen for login to the messenger application according to the embodiment of the present invention.

FIG. 14 illustrates a user information input screen of the messenger application according to the embodiment of the present invention.

FIG. 15 illustrates a group screen of the messenger application according to the embodiment of the present invention.

FIG. 16 illustrates an individual screen of the messenger application and submenus of the individual screen according to the embodiment of the present invention.

FIG. 17 illustrates a conversation list screen of the messenger application according to the embodiment of the present invention.

FIG. 18 illustrates another-on screen of the messenger application according to the embodiment of the present invention.

FIG. 19 illustrates a victim information screen of the messenger application according to the embodiment of the present invention.

FIG. 20 illustrates a conversation window screen of a conversation group of the messenger application according to the embodiment of the present invention.

FIG. 21 illustrates an option setting screen of the messenger application according to the embodiment of the present invention.

FIG. 22 illustrates a screen on which a conversation window of a conversation group of the messenger application according to the embodiment of the present invention is displayed as a pop-up window.

FIG. 23 illustrates screens on which victim information of the messenger application according to the embodiment of the present invention is displayed as a pop-up window.

FIG. 24 illustrates screens for describing a process of creating an individual conversation group of the messenger application according to the embodiment of the present invention.

FIG. 25 illustrates screens for describing a process of activating a conversation window of a conversation group of the messenger application according to the embodiment of the present invention.

FIG. 26 illustrates screens for describing a process of moving to a conversation window of a conversation group of the messenger application according to the embodiment of the present invention.

FIG. 27 illustrates screens for describing a conversation on a conversation window of a conversation group of the messenger application according to the embodiment of the present invention.

FIG. 28 illustrates screens for describing a call function on a conversation window of the messenger application according to the embodiment of the present invention.

### BEST MODE

Hereinafter, exemplary embodiments of the present invention will be described in detail with reference to the accompanying drawings. Specific matters such as names and constituent elements, for example, a messenger application and conversation group will be described below, which are provided only for a better understanding of the present invention. Accordingly, it will be apparent to those skilled in the art that the specific matters can be variously modified and changed without departing from the spirit or scope of the invention. In this specification, the terms such as “first” and “second” may be used to describe various components regardless of the order and/or importance thereof. The terms are used only to distinguish one component from another component, and do not limit the components. For example, first and second electronic devices may indicate different user devices regardless of the order or importance thereof. For example, a first component may be referred to as a second component within the scope of the present invention. Similarly, the second component may also be referred to as the first component. Moreover, when a component (for example, first component) is referred to as being “operatively or communicatively coupled or connected” to another component (for example, second component), it may indicate that the former component can be directly coupled to the latter component or coupled through another component (for example, third component). On the other hand, when a component (for example, first component) is referred to as being “directly coupled” or “directly connected” to another component (for example, second component), it may indicate that another component (for example, third component) is not present between the former and latter components.

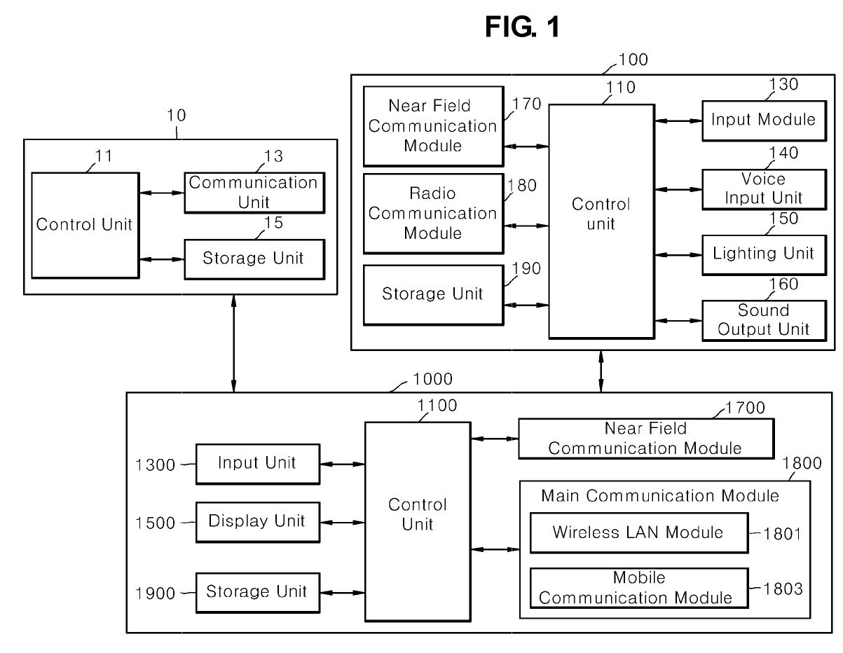

FIG. 1 is a block diagram of an industrial communication system according to an embodiment of the present invention. Referring to FIG. 1, the industrial communication system may include a server 10, an electronic device 1000 and an industrial communication device 100.

The server 10 may include a control unit 11, a communication unit 13 and a storage unit 15.

The control unit 11 may transmit a messenger application stored in the storage unit 15 to the electronic device 1000 through the communication unit 13.

The messenger application may include a software program designed to enable users of the messenger application to send and/or receive a message and data therebetween in real time. Furthermore, one or more conversation groups including one or more contacts may be set in the messenger application through a user manipulation. When a first electronic device having the messenger application installed therein receives a voice signal from an industrial communication device coupled to the first electronic device, the voice signal being supposed to be transmitted to a contact or contacts included in a specific conversation group of the messenger application, the first electronic device may transmit the voice signal to the corresponding electronic device or electronic devices (second electronic devices) of the contact or contacts. The voice signal transmitted to the second electronic device may be transmitted to another industrial communication device coupled to the second electronic device. Moreover, the first electronic device may receive from the second electronic device a voice signal which is supposed to be transmitted to the industrial communication device coupled to the first electronic device. When the first electronic device receives the voice signal which is supposed to be transmitted to the industrial communication device coupled to the first electronic device, the first electronic device may transmit the corresponding voice signal to the industrial communication device coupled to the first device. The messenger application will be described in more detail later.

The electronic device 1000 may include a control unit 1100, an input unit 1300, a display unit 1500, a near field communication module 1700, a main communication module 1800 and a storage unit 1900. The electronic device 1000 may include various electronic devices such as a computer, table PC and smart phone which are not illustrated.

The input unit 1300 may be implemented with a touch screen (not illustrated) for receiving a manipulation of a user, and include a keyboard, mouse, voice input unit, button and the like which are not illustrated.

The display unit 1500 may display execution images, operation states and menu states of various application programs. The display unit 1500 may be integrated with the touch screen.

The near field communication module 1700 may perform a wireless signal processing operation for near field communication with an external device such as the industrial communication device 100. The near field communication module 1700 may include one or more of WiFi (Wireless Fidelity), Bluetooth or NFC (Near Field Communication).

The main communication module 1800 may include a wireless LAN module 1801 and a mobile communication module 1803, and perform a wireless signal processing operation for wireless communication with an external device such as the server 10 or an electronic device.

The wireless LAN module 1801 may be coupled to the Internet at a place where an AP (Access Point) is installed, according to control of the control unit 1100.

The mobile communication module 1803 may transmit/receive a wireless signal for a voice call, video call, text message (SMS) or multimedia message (MMS) to/from a mobile phone, smart phone, table PC or another device having a telephone number inputted to the electronic device 100. The mobile communication module 1803 may use one or more of LTE (Long-Term Evolution), LTE-A (LTE Advance), CDMA (Code Division Multiple Access), WCDMA (Wideband CDMA), UMTS (Universal Mobile Telecommunications System), WiBro (Wireless Broadband) and GSM (Global System for Mobile Communications).

The storage unit 1900 may store a signal or data which is inputted/outputted in response to an operation of the input unit 1300, the display unit 1500, the near field communication module 1700 or the main communication module 1800 according to control of the control unit 1100. The storage unit 1900 may store control programs and applications for controlling the electronic device 1000 or the control unit 1100.

The term “storage unit” may include the storage unit 1900, a ROM and RAM (not illustrated) in the control unit 1100, and a memory card (not illustrated) mounted in the electronic device 1000 (for example, SD card and memory stick).

The ROM included in the control unit 1100 may store a control program for controlling a CPU and the electronic device 1000, and the RAM included in the control unit 1100 may store a signal or data inputted from outside the electronic device 1000 or serve as a memory area for an operation performed by the electronic device 1000.

The control unit 1100 may control the overall functional units (the input unit 1300, the display unit 1500, the near field communication module 1700, the main communication module 1800 and the storage unit 1900).

According to an embodiment, when receiving a voice signal corresponding to a first voice from the industrial communication device 100 paired through the near field communication module 1700, the control unit 1100 may confirm one or more contact connected to a conversation group of the messenger application, and transmit a voice message corresponding to the first voice to the corresponding device of the confirmed contact using the main communication module 1800.

According to an embodiment, when receiving the voice signal corresponding to the first voice from the industrial communication device 100 paired through the near field communication module 1700, the control unit 1100 may control the display unit 1500 to display a visual effect corresponding to the first voice.

According to an embodiment, when receiving the voice signal corresponding to the first voice from the industrial communication device 100 paired through the near field communication module 1700, the control unit 1100 may control the storage unit 1900 to store voice data corresponding to the first voice.

According to an embodiment, when receiving a voice message corresponding to a second voice from the corresponding device through the main communication module 1800, the control unit 1100 may control the near field communication module 17000 to transmit a voice signal corresponding to the second voice to the industrial communication device 100.

According to an embodiment, when receiving the voice message corresponding to the second voice from the corresponding device through the main communication module 1800, the control unit 1100 may control the display unit 1500 to display a visual effect corresponding to the second voice.

According to an embodiment, when receiving the voice message corresponding to the second voice from the corresponding device through the main communication module 1800, the control unit 1100 may control the storage unit 1900 to store voice data corresponding to the second voice.

According to an embodiment, when receiving a signal corresponding to a first accident alarm from the industrial communication device 100 paired through the near field communication module 1700, the control unit 1100 may control the main communication module 1800 to transmit a message corresponding to the first accident alarm to the corresponding device or devices of one or more contacts connected to the messenger application.

According to an embodiment, when receiving a message corresponding to a second accident alarm from the corresponding device through the main communication module 1800, the control unit 1100 may control the near field communication module 1700 to transmit a signal corresponding to the second accident alarm to the industrial communication device 100, and control the display unit 1500 to display information corresponding to the second accident alarm.

The message corresponding to the first accident alarm and the message corresponding to the second accident alarm may include one or more of an accident date, the information of an accident victim or an accident location. The industrial communication device 100 may include a control unit 110, an input module 130, a voice input unit 140, a lighting unit 150, a sound output unit 160, a near field communication module 170, a radio communication module 180 and a storage unit 190.

The input module 130 may include a button (not illustrated) for receiving a manipulation of a user.

The voice input unit 140 may receive a voice from the user. The voice input unit 140 may include a microphone, for example. The voice inputted through the voice input unit 140 may be converted into a voice signal corresponding to an electrical signal, according to control of the control unit 110. The voice signal may be transferred to the near field communication module 170 or the radio communication module 180, and then transmitted to the outside.

The lighting unit 150 may include one or more LED lightings.

The sound output unit 160 may output a voice corresponding to a voice signal received from outside and a sound corresponding to a sound signal received from outside. The sound output unit 160 may include a speaker and earphone, for example.

The near field communication module 170 may perform a wireless signal processing operation for near field communication with an external device such as the electronic device 1000. The near field communication module 170 may include one or more of WiFi, Bluetooth and NFC, for example.

The radio communication module 180 may transmit/receive FRS (Family Radio Service) signals. The radio communication module 180 may include a communication module (not illustrated) for performing long distance communication in the range of 100 m or more. For example, the radio communication module 180 may use an FRS (Family Radio System or Family Radio Service) to perform wireless communication in the range of 1 km or more, through a channel allocated between 448.75 Mhz and 449.263 Mhz.

The storage unit 190 may store a signal or data which is inputted/outputted in response to an operation of the input module 130, the voice input unit 140, the lighting unit 150, the sound output unit 160, the near field communication module 170 or the radio communication module 180 according to control of the control unit 110. Furthermore, when the industrial communication device 100 is set in a state corresponding to an accident occurrence, the storage unit 190 may store a sound corresponding to the accident occurrence.

The control unit 110 may control the overall functional units (the input module 130, the voice input unit 140, the lighting unit 150, the sound output unit 160, the near field communication module 170, the radio communication module 180 and the storage unit 190).

According to an embodiment, the control unit 110 may decide whether to execute the radio communication function or near field communication function depending on a user manipulation inputted through the input module 130. When a first voice is inputted through the voice input unit 140 after the execution of the radio communication function was decided, the control unit 110 may transmit a voice signal corresponding to the first voice to the outside using the radio communication module 180. On the other hand, when a second voice is inputted through the voice input unit 140 after the execution of the near field communication function was decided, the control unit 110 may transmit a voice signal corresponding to the second voice to the electronic device 1000 paired through the near field communication module 170.

According to an embodiment, when the execution of the radio communication function is decided, the control unit 110 may turn on a first lighting included in the lighting unit 150. On the other hand, when the execution of the radio communication function is decided, the control unit 110 may turn on a second lighting included in the lighting unit 150.

According to an embodiment, when receiving a signal corresponding to a third voice from the electronic device 1000 paired through the near field communication module 170, the control unit 110 may output the third voice through the sound output unit 160. Furthermore, when receiving a signal corresponding to a fourth voice from another industrial communication device through the radio communication module 180, the control unit 110 may output the fourth voice through the sound output unit 160.

Moreover, according to a user manipulation inputted through the input module 130, the control unit 110 may transmit a signal to the electronic device 1000 through the near field communication module 170, the signal serving to activate another conversation group instead of the currently activated conversation group among the conversation groups of the messenger application of the electronic device 1000.

According to an embodiment, the control unit 110 may change a radio channel set to the radio communication module 180 to any one radio module of designated radio channels, according to a user manipulation inputted through the input module 130.

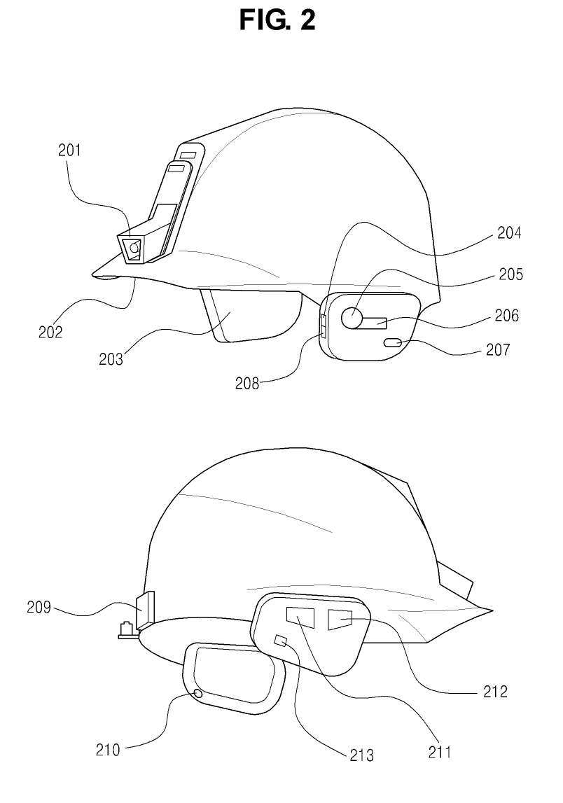

FIG. 2 illustrates an industrial communication device according to an embodiment of the present invention. Referring to FIG. 2, the industrial communication device may be implemented as a safety helmet, and the safety helmet may include an LED lighting 201 (for example, the lighting unit 150), a microphone 202 (for example, the voice input unit 140), a speaker 203 (the sound output unit 160), a channel change button 204, a 400M PTT (Push To Talk) button 205, a volume button 206, a power/status light 207, a power button 208, an external battery connection jack 209, an earphone connection jack 210, a lighting power button 211, an IP (Internet Protocol) PTT button 212 and a charging LED 213.

One or more of the channel change button 204, the 400M PTT button 205, the volume button 206, the power button 208, the lighting power button 211 and the IP PTT button 212 may be included in the input module 130 illustrated in FIG. 1.

The channel change button 204 may include UP and DOWN keys (not illustrated), for example.

According to an embodiment, the channel change button 204 may be used to select a wireless communication function or radio communication function. For example, when a user presses the UP key, the radio communication function may be executed, and when the user presses the DOWN key, the near field communication function may be executed.

According to an embodiment, the channel change button 204 may be used to change a radio channel of the radio communication module (for example, the radio communication module 180). For example, when a user presses the UP key for a long time or then presses the UP or DOWN key for a short time, the previously set radio channel may be changed to any one radio channel of the designated radio channels. In addition, when the radio channel is changed, the changed radio channel number may be outputted through the speaker 203 according to control of the control unit of the safety helmet (for example, the control unit 110).

According to an embodiment, the channel change button 204 may be used to transmit a signal to the electronic device 1000 through the near field communication module 170, the signal serving to activate another conversation group instead of the currently activated conversation group among the conversation groups of the messenger application of the electronic device 1000. For example, when a user presses the DOWN key for a long time and then presses the UP or DOWN key for a short time, the currently activated conversation group may be changed to any one conversation group of the designated conversation groups. In addition, when the conversation group is changed, the name of the changed group may be outputted through the speaker 203 according to control of the control unit of the safety helmet. The conversation group may be selected among registered groups. For example, the conversation group may be selected among groups set by the user according to a user manipulation.

The 400M PTT button 205 may be used for voice transmission using the 400 MHz band. According to an embodiment, the 400M PTT button 205 may be used to transmit a voice through radio communication.

The volume button 206 may adjust the sound volume of the speaker 203. According to an embodiment, the volume button 206 may include + and − buttons, and a user can adjust the output volume of the speaker 203 by pressing the + or − button for a short time of 0.5 second, for example. For example, the output voltage may be set in the range of first to fourth stages.

The power button 208 may be used to power on or off the safety helmet. According to an embodiment, when a user presses the power button 208 for a long time (for example, 2 seconds) while the safety helmet is powered off, the safety helmet may be powered on. Furthermore, when the safety helmet is powered on, a sound and/or voice notifying that the safety helmet is powered on may be outputted through the speaker 203 according to control of the control unit of the safety helmet. For example, a voice saying “Power on” may be outputted. Moreover, a specific color of LED (not illustrated) included in the power/status light 207 illustrated in FIG. 2 (for example, lighting unit 150) may be turned on. When the user presses the power button 208 for a long time while the safety helmet is powered on, the safety helmet may be powered off. In addition, when the safety helmet is powered off, a sound and/or voice notifying the power-off may be outputted through the speaker 203, and the LED may be turned off, according to control of the control unit. For example, a voice saying “Power off” may be outputted.

According to an embodiment, the power button 208 may indicate the status information of the safety helmet. The status information of the safety helmet may include a battery power level and a connection status of wireless communication. For example, when the user presses the power button 208 for a short time regardless of whether the wireless communication function or the near field communication function is activated, the status information may be outputted as a voice through the speaker 203 according to control of the control unit of the safety helmet. For example, when the user presses the power button 208 for a short time, a voice saying “battery power level xx%” may be outputted through the speaker 203. Furthermore, the connection status of the wireless communication may be classified into three cases, for example, and a voice indicating the connection status of the wireless communication may be outputted through the speaker 203.

For example, when the user presses the power button 208 for a short time while the electronic device 1000 and the safety helmet are connected through the near field communication module and the messenger application of the electronic device 1000 is enabled, a voice saying “Normally connected” may be outputted through the speaker 203.

Moreover, when the user presses the power button 208 for a short time while the electronic device 1000 and the safety helmet are not connected to each other, a voice saying “Check communication status” may be outputted through the speaker 203.

Furthermore, when the user presses the power button 208 for a short time while the electronic device 1000 and the safety helmet are connected through the near field communication module but the messenger application of the electronic device 1000 is disabled, a voice saying “Check messenger application” may be outputted through the speaker 203. The messenger application may be disabled when an error occurs in the messenger application or the messenger application is not installed in the electronic device.

The lighting power button 211 may be used to turn on or off the LED lighting 201 of the safety helmet. According to an embodiment, when a user presses the lighting power button 211, the LED lighting 201 may be turned on or off.

The IP PTT button 212 may be used for voice transmission using the IP PTT. According to an embodiment, the IP PTT button 212 may be used to transmit a voice through near field communication.

The external battery connection jack 209 may be connected to an external battery. According to an embodiment, when an external battery is connected to the external battery connection jack 209, a battery embedded in the safety helmet may be charged. Furthermore, the battery charging may be checked through the charging LED 213. The charging LED 213 may include two LEDs (not illustrated) having different colors. For example, when the battery is being charged, a first LED may be turned on, and when the battery charging is completed, a second LED may be turned on.

The earphone connection jack 210 may be connected to an earphone. According to an embodiment, when the earphone is connected to the earphone connection jack 210, all sounds may be outputted through the earphone. When the connection between the earphone connection jack 210 and the earphone is removed, a sound may be outputted through the speaker 203.

The industrial communication device 100 may be applied to various protection gears such as a safety belt other than the safety helmet.

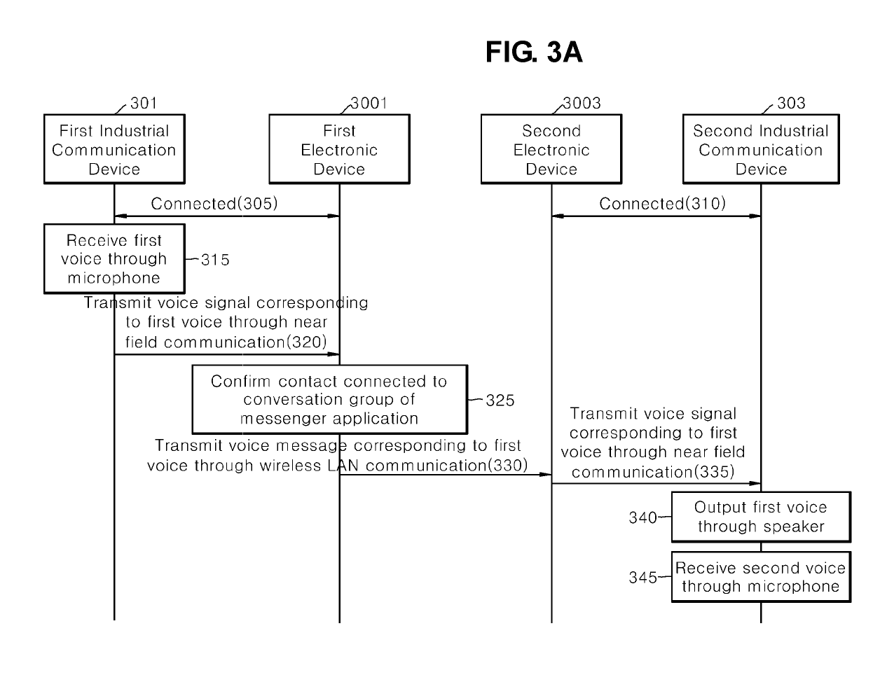

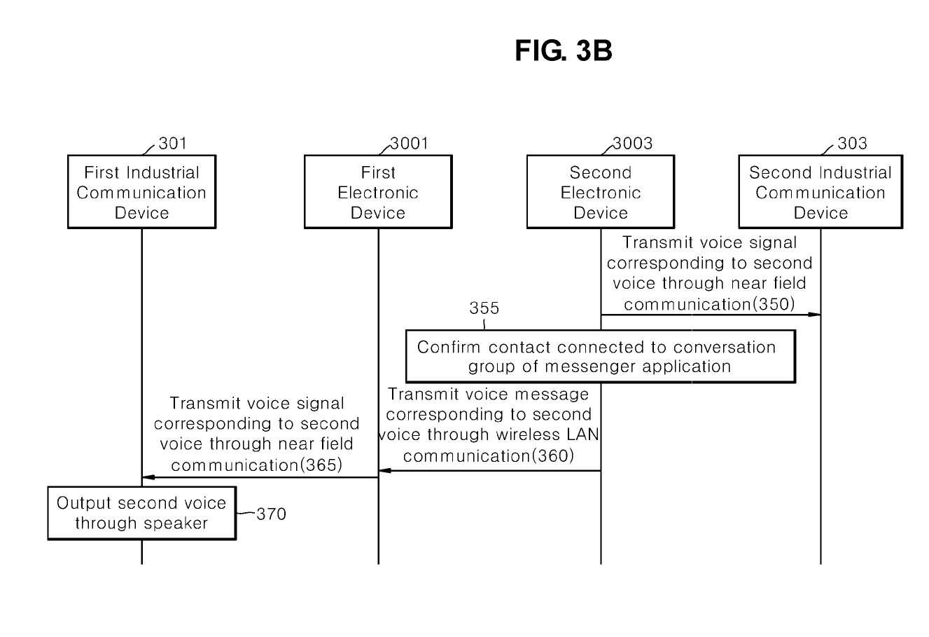

FIGS. 3A and 3B are flowcharts illustrating an operation of an industrial communication system according to an embodiment of the present invention. Referring to FIGS. 3A and 3B, a first industrial communication device 301 may execute a near field communication function to transmit a voice signal corresponding to a specific voice to a second industrial communication device 303 corresponding to an industrial communication device of a desired contact, through near field communication with a first electronic device 3001. Then, the contact can hear the specific voice through the second industrial communication device 303. The contact may be included in a conversation group of a messenger application installed in the first electronic device 3001. Moreover, the first industrial communication device 301 may receive a voice signal corresponding to a specific voice inputted by the user of the second industrial communication device 303 from the second industrial communication device 303 through near field communication with the first electronic device 3001. Then, a user of the first industrial communication device 301 can hear the voice inputted by the user of the second industrial communication device 303. The user of the first industrial communication device 301 may be included in a conversation group of a messenger application installed in the second industrial communication device 303.

At operation 305, the first industrial communication device 301 and the first electronic device 3001 may be connected to each other through near field communication.

At operation 310, the second electronic device 3003 and the second industrial communication device 303 may be connected to each other through near field communication.

Under the supposition that the near field communication is Bluetooth communication, the connection between the first industrial communication device 301 and the first electronic device 3001 will be described as follows.

According to an embodiment, when there is no connection information between the first industrial communication device 301 and the first electronic device 3001 or an industrial communication device (not illustrated) other than the first industrial communication device 301 is connected to the first electronic device 3001, Bluetooth communication between the first industrial communication device 301 and the first electronic device 3001 may be manually achieved according to the following sequence. First, the first electronic device 3001 may enable a Bluetooth function, and then search for the first industrial communication device 301 through a search function. Then, the first electronic device 3001 may check the designated serial number of the first industrial communication device 301, make a registration request for the serial number, and confirm that the first electronic device 3001 and the first industrial communication device 301 are connected to each other through the Bluetooth communication. In addition, when it is confirmed that the first electronic device 3001 and the first industrial communication device 301 were connected to each other through the Bluetooth communication, the first electronic device 3001 may output a voice saying “Connected” through the speaker thereof, or display a visual effect indicating the connection on the screen. Furthermore, when it is confirmed that the first electronic device 3001 and the first industrial communication device 301 were connected to each other through the Bluetooth communication, the first industrial communication device 301 may output a voice saying “Hands-free connected” through the speaker thereof.

According to an embodiment, when a device which is finally paired with the first industrial communication device 301 is the first electronic device 3001 and when the first industrial communication device 301 is present in a device list registered for the Bluetooth communication of the first electronic device 3001, the first industrial communication device 301 and the first electronic device 3001 may be automatically connected to each other through the Bluetooth communication.

According to an embodiment, when the first industrial communication device 301 is connected to another electronic device instead of the first electronic device 3001 which wants Bluetooth communication, the first industrial communication device 301 may be reset through a user manipulation. For example, the user may power off the first industrial communication device 301, and press a power button (for example, the power button 208) of the first industrial communication device 301 while pressing an IP PTT button (for example, the IP PTT button 212) of the first industrial communication device 301. Then, the first industrial communication device 301 and the first electronic device 3001 may be connected to each other through the Bluetooth communication, according to the above-described manual connection method.

According to an embodiment, when the first electronic device 3001 executes the messenger application, the first electronic device 3001 and the first industrial communication device 301 may be automatically connected to each other through the Bluetooth communication. When the first electronic device 3001 and the first industrial communication device 301 are connected to each other through the Bluetooth communication according to the execution of the messenger application, the first industrial communication device 301 may output a voice saying “Messenger application connected” through the speaker thereof, and an LED lighting (for example, the LED lighting 201) of the first industrial communication device 301 may be turned on. For example, the LED lighting 201 may blink twice.

The connection between the second industrial communication device 303 and the second electronic device 3003 may be achieved according to the above-described embodiments.

At operation 315, the first industrial communication device 301 may receive a first voice through the microphone of the first industrial communication device 301. For example, when the IP PTT button (for example, the IP PTT button 212) of the first industrial communication device 301 is pressed by a manipulation of the user, a beep sound is outputted once through the speaker of the first industrial communication device 301, and the user inputs the first voice, the first industrial communication device 301 may transmit a first voice signal corresponding to the first voice to the first electronic device 3001. At this time, the LED lighting of the first industrial communication device 301 may be turned on. The voice input of the user and the transmission of the first voice signal may be performed while the IP PTT button is pressed.

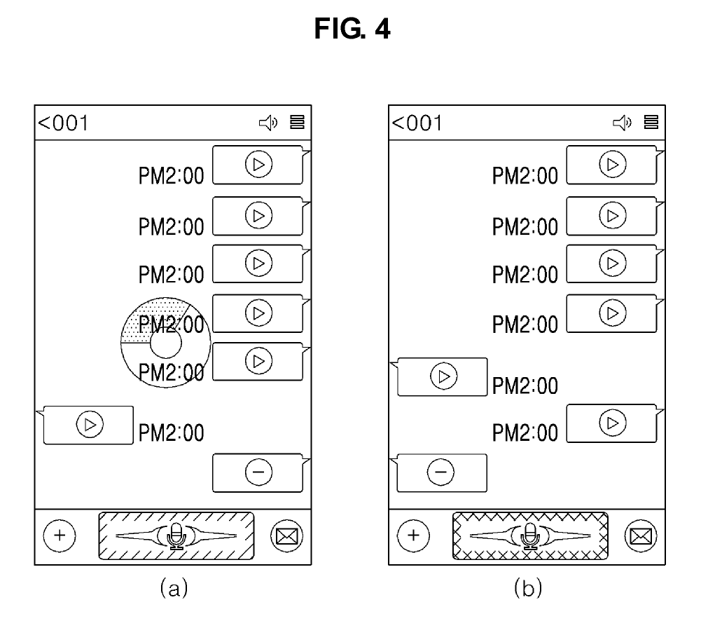

At operation 320, the first industrial communication device 301 may transmit a voice signal corresponding to the first voice to the first electronic device 3001 through the near field communication. For example, when the first electronic device 3001 receives the voice signal corresponding to the first voice, the first electronic device 3001 may store voice data corresponding to the first voice. Furthermore, when the first electronic device 3001 receives the voice signal corresponding to the first voice, a visual effect corresponding to the first voice may be displayed on the corresponding conversation window of the conversation group of the messenger application of the first electronic device 3001 as illustrated in FIG. 4(a). The visual effect may include the storage time of the voice data corresponding to the first voice. When the storage time of the voice data is displayed on the conversation window, the following operation 330 may be executed. When the pressing of the IP PTT button is removed and a beep sound is outputted twice through the speaker of the first industrial communication device 301, the first industrial communication device 301 may stop transmitting the voice signal to the first electronic device 3001. In addition, when the pressing of the IP PTT button is removed and a beep sound is outputted twice through the speaker of the first industrial communication device 301, the LED lighting of the first industrial communication device 301 may be turned off.

At operation 325, the first electronic device 3001 may confirm a contact connected to the conversation group of the messenger application.

At operation 330, the first electronic device 3001 may transmit a voice message corresponding to the first voice to the second electronic device 3003 through wireless LAN communication.

When the second electronic device 3003 receives the voice message corresponding to the first voice, a visual effect corresponding to the first voice may be displayed on the corresponding conversation window of the conversation group of the messenger application of the second electronic device 3003 as illustrated in FIG. 4(b).

At operation 335, the second electronic device 3003 may transmit the voice signal corresponding to the first voice to the second industrial communication device 303 through the near field communication.

At operation 340, the second industrial communication device 303 may output the first voice through the speaker thereof. For example, when receiving the voice signal corresponding to the first voice, the second industrial communication device 303 may output a beep sound once through the speaker thereof. Moreover, when the second industrial communication device 303 receives the voice signal corresponding to the first voice, the LED lighting of the second industrial communication device 303 may be turned on. Furthermore, when the transmission of the voice signal of the second electronic device is completed, the second industrial communication device 303 output a beep sound twice through the speaker thereof. In addition, when the transmission of the voice signal of the second electronic device is completed, the LED lighting may be turned off.

At operation 345, the second industrial communication device 303 may receive a second voice from the user through the microphone thereof.

At operation 350, the second industrial communication device 303 may transmit a voice signal corresponding to the second voice to the second electronic device 3003 through the near field communication.

At operation 355, the second electronic device 3003 may confirm a contact connected to the conversation group of the messenger application.

At operation 360, the second electronic device 3003 may transmit a voice message corresponding to the second voice to the first electronic device 3001 through wireless LAN communication.

At operation 365, the first electronic device 3001 may transmit the voice signal corresponding to the second voice to the first industrial communication device 301 through the near field communication.

At operation 370, the first industrial communication device 301 may output the second voice through the speaker thereof.

The detailed descriptions of operations 345 to 370 according to the present embodiment correspond to those of the above-described operations 315 to 340, and are thus omitted herein.

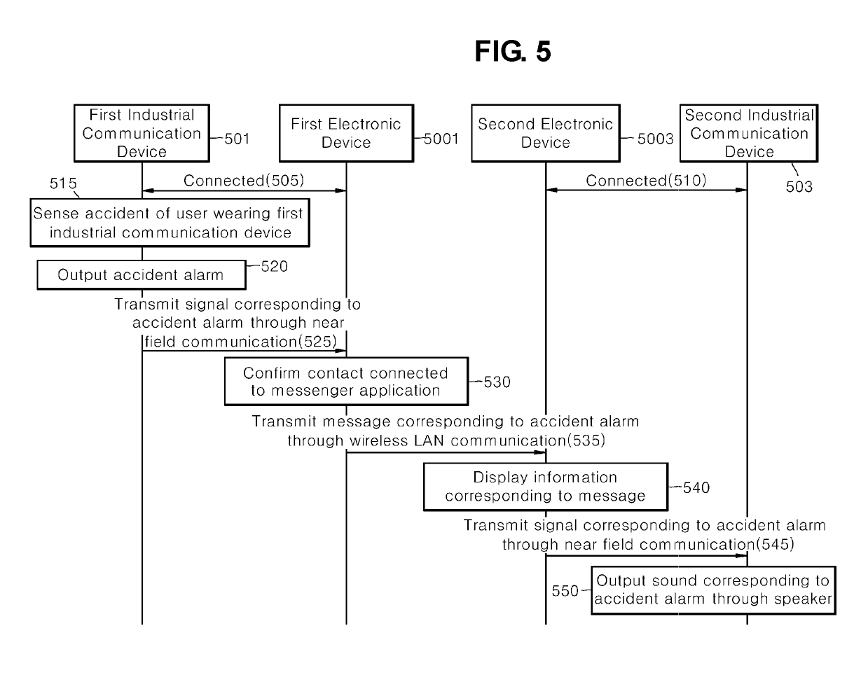

FIG. 5 is a flowchart illustrating an operation of an industrial communication system according to another embodiment of the present invention. Referring to FIG. 5, when an accident of a user wearing a first industrial communication device 501 is sensed, the first industrial communication device 501 may execute the near field communication function to transmit a signal notifying the accident occurrence to a second industrial communication device 503 corresponding to an industrial communication device of a desired contact through near field communication with a first electronic device 5001. Then, the contact can recognize the accident of the user wearing the first industrial communication device 501 through the second industrial communication device 503. The contact may be included in an application installed in the first electronic device 5001.

At operation 505, the first industrial communication device 501 and the first electronic device 5001 may be connected to each other through near field communication. At operation 510, a second electronic device 5003 and the second industrial communication device 503 may be connected to each other through near field communication.

At operation 515, the first industrial communication device 501 may sense the accident of the user wearing the first industrial communication device 501. According to an embodiment, when the first industrial communication device 501 senses a shock with a magnitude equal to or more than a predetermined reference value through a sensor unit (not illustrated), for example, a shock sensor, the first industrial communication device 501 may determine that the user of the first industrial communication device 501 had an accident. Moreover, when the first industrial communication device 501 senses a fall of the user wearing the first industrial communication device 501 through the sensor unit including one or more of a tilt sensor, the shock sensor and a gyro sensor, the first industrial communication device 501 may determine that the user of the first industrial communication device 501 had an accident. For example, the tilt sensor and/or the gyro sensor may sense a fall down of the user or sense whether the user has not moved for a long time, and the shock sensor may sense a collision or fall of the user.

At operation 520, the first industrial communication device 501 may output an accident alarm. According to an embodiment, when the accident of the user is sensed, the first industrial communication device 501 may output the accident alarm. For example, when a shock is sensed, the first industrial communication device 501 may output a voice saying “Shock sensed. Are you Okay?” through the speaker thereof. Moreover, when a fall is sensed, the first industrial communication device 501 may output a voice saying “Fall sensed. Are you Okay?” through the speaker thereof. The accident alarm may be generated on a predetermined time basis (for example, five seconds).

According to an embodiment, when outputting the accident alarm, the first industrial communication device 501 may clear the accident alarm according to a user manipulation. For example, when the user presses any one of the buttons of the first industrial communication device 501, the first industrial communication device 501 may end the output of the accident alarm by clearing the accident alarm. When the accident alarm is cleared, the first industrial communication device 501 may output a voice saying “Accident sensing stopped” through the speaker thereof.

According to an embodiment, when the accident alarm is not cleared for a predetermined time after the accident alarm has been outputted, the industrial communication device 501 may perform the following operation 525.

At operation 525, the first industrial communication device 501 may transmit a signal corresponding to the accident alarm to the first electronic device 5001 through the near field communication. For example, while transmitting the signal corresponding to the accident alarm, the first industrial communication device 501 may output a voice “Sending accident information” through the speaker thereof.

At operation 530, the first electronic device 5001 may confirm a contact connected to the messenger application. The contact may be previously specified in the first industrial communication device 501 or the first electronic device 5001 such that the signal corresponding to the accident alarm is transmitted to the contact. For example, the contact may include a manager and a group to which the user of the first industrial communication device 501 belongs.

At operation 535, the first electronic device 5001 may transmit a message corresponding to the accident alarm to the second electronic device 5003 through wireless LAN communication.

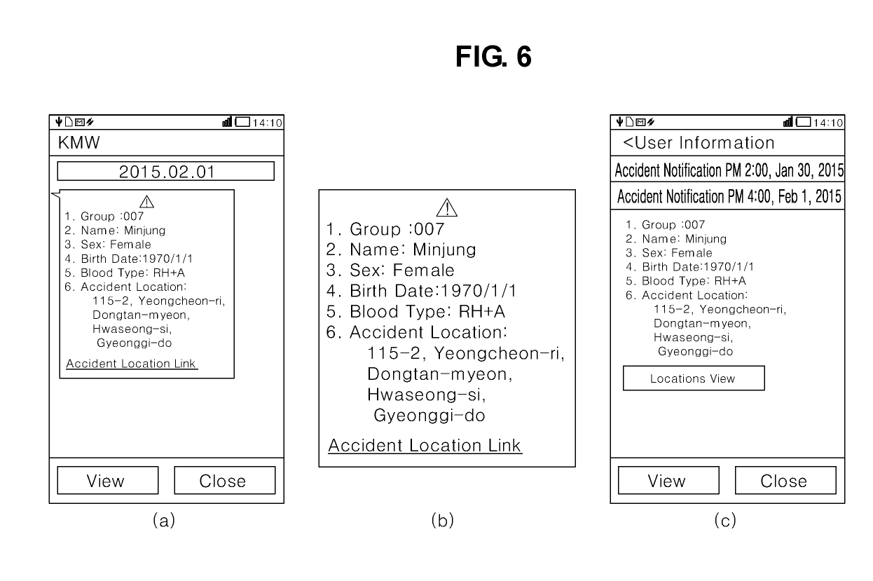

At operation 540, the second electronic device 5003 may display information corresponding to the message. According to an embodiment, the information corresponding to the message may be displayed in the form of a pop-up window as illustrated in any one of FIGS. 6(a) to 6(c). The information corresponding to the message may include any one of the group, name, sex, birth date and blood type of the user and the accident location, for example. When the pop-up window is closed, the user may execute a user information item among other items of the messenger application, in order to recheck the accident alarm.

At operation 545, the second electronic device 5003 may transmit a signal corresponding to the accident alarm to the second industrial communication device 503 through the near field communication.

At operation 550, the second industrial communication device 503 may output a sound corresponding to the accident alarm through the speaker thereof. For example, the sound corresponding to the accident alarm may include a voice saying “Accident victim found”.

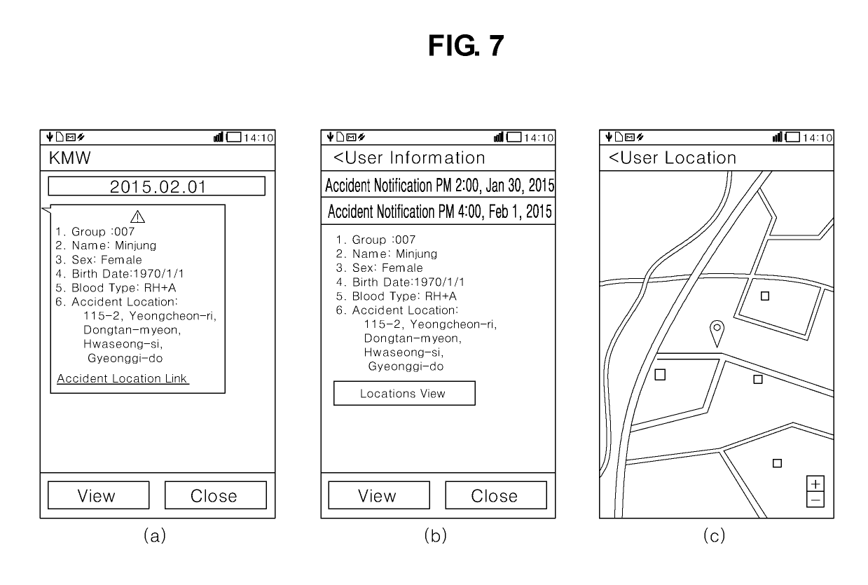

According to a manipulation of the user, the accident alarm of the second industrial communication device 503 may be cleared. According to an embodiment, the accident alarm may be cleared by the second electronic device 5003 connected to the second industrial communication device 503. When the location of the accident victim is confirmed by the second electronic device 5003, the accident alarm may be cleared, and the output of the accident alarm may be ended. When “Victim location link” is selected from the pop-up window displayed on the screen of the second electronic device 5003 according to a user manipulation as illustrated in FIG. 7(a), a victim information window may be displayed as illustrated in FIG. 7(b). Then, when “Locations view” displayed on the victim information window is selected according to a user manipulation, the location of the victim may be displayed as illustrated in FIG. 7(c). When the location of the victim is confirmed, the accident alarm may be cleared, and the output of the accident alarm may be ended.

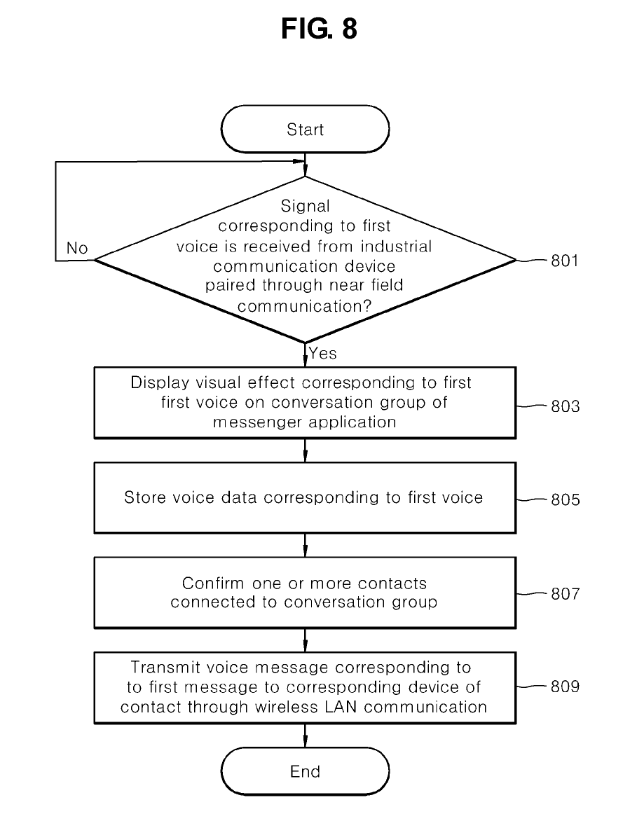

FIG. 8 is a flowchart an illustrating an operation of an electronic device to control an industrial communication device according to an embodiment of the present invention. Referring to FIG. 8, when the electronic device receives a signal corresponding to a first voice from the industrial communication device paired through near field communication, the electronic device may perform an operation of confirming one or more contacts connected to a conversation group of a messenger application, and an operation of transmitting voice data corresponding to the first voice to the corresponding device or devices of the confirmed contact or contacts through wireless LAN communication.

At operation 801, the electronic device may determine whether the signal corresponding to the first voice is received from the industrial communication device paired through the near field communication. The electronic device may perform operation 803 when the signal corresponding to the first voice is received from the industrial communication device paired through the near field communication, or re-perform operation 801 when the signal corresponding to the first voice is not received.

At operation 803, the electronic device may display a visual effect corresponding to the first voice on a conversation window of the messenger application. The visual effect may be displayed as a predetermined image indicating that the first voice was received. The visual effect may include the time at which the first voice was received. Furthermore, the visual effect may include the capacity of the first voice.

At operation 805, the electronic device may store voice data corresponding to the first voice.

At operation 807, the electronic device may confirm one or more contacts connected to the conversation group.

At operation 809, the electronic device may transmit a voice message corresponding to the first voice to the corresponding device or devices of the contact or contacts through wireless LAN communication.

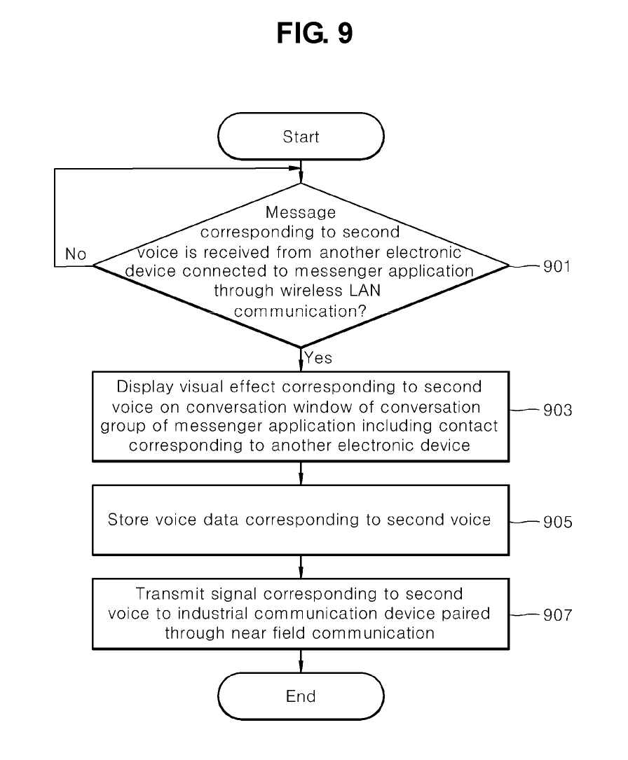

FIG. 9 is a flowchart illustrating an operation of an electronic device to control an industrial communication device according to another embodiment of the present invention. Referring to FIG. 9, when the electronic device receives a message corresponding to a second voice from another electronic device through wireless LAN communication, the electronic device may transmit a signal corresponding to the second voice to an industrial communication device paired through near field communication.

At operation 901, the electronic device may determine whether the message corresponding to the second voice is received from another electronic device connected to a messenger application through wireless LAN communication. The electronic device may perform operation 903 when the message corresponding to the second voice is received from the another electronic device connected to the messenger application through the wireless LAN communication, or re-perform operation 901 when the message corresponding to the second voice is not received.

At operation 903, the electronic device may display a visual effect corresponding to the second voice on a conversation window of a conversation group of the messenger application, the conversation group including the contact corresponding to the another electronic device. The visual effect may be displayed as a predetermined image indicating that the second voice was received. The visual effect may include the time at which the second voice was received. Moreover, the visual effect may include the capacity of the first voice.

At operation 905, the electronic device may store voice data corresponding to the second voice.

At operation 907, the electronic device may transmit a signal corresponding to the second voice to an industrial communication device paired through near field communication.

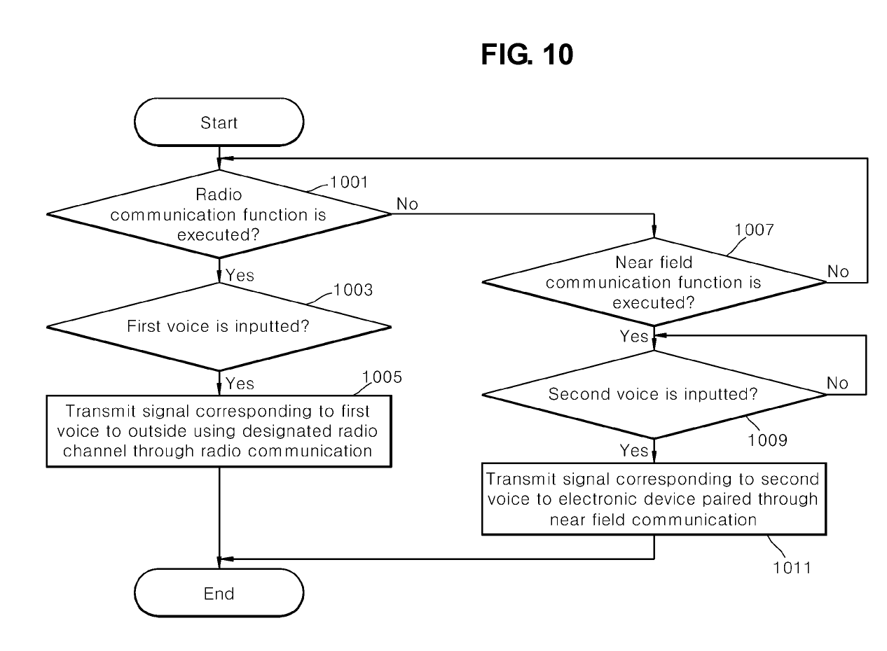

FIG. 10 is a flowchart illustrating an operation of an industrial communication device according to an embodiment of the present invention. Referring to FIG. 10, the industrial communication device may include an operation of deciding whether to execute a radio communication function or near field communication function according to a user manipulation, an operation of transmitting a voice signal corresponding to a first voice to the outside through a designated radio channel through radio communication when the first voice is inputted through a voice input unit of the industrial communication device after the execution of the radio communication function was decided, and an operation of transmitting a voice signal corresponding to a second voice to an electronic device paired through near field communication when the second voice is inputted through the voice input unit of the industrial communication device after the execution of the near field communication function was decided.

At operation 1001, the industrial communication device may determine whether to execute the radio communication function. The industrial communication device may perform operation 1003 when the radio communication function is executed, or perform operation 1007 when the radio communication function is not executed. According to an embodiment, when a PTT button (for example, the 400M PTT button 205) of the industrial communication device is pressed by a user manipulation and a beep sound is outputted once through the speaker of the industrial communication device, the radio communication function may be executed.

At operation 1003, the industrial communication device may determine whether the first voice is inputted. The industrial communication device may perform operation 1005 when the first voice is inputted, or re-perform operation 1003 when the first voice is not inputted.

At operation 1005, the industrial communication device may transmit a signal corresponding to the first voice to the outside using a designated radio channel through radio communication.

When a user inputs a voice after the execution of the wireless communication function, the industrial communication device may transmit a signal corresponding to the input voice to another industrial communication device. In addition, an LED lighting of the industrial communication device may be turned on. The voice input of the user and the transmission of the voice signal corresponding to the voice may be performed while the PTT button is pressed.

Furthermore, when the pressing of the PTT button is removed and a beep sound is outputted twice through the speaker of the industrial communication device, the industrial communication device may stop transmitting the voice signal corresponding to the input voice. In addition, the LED lighting of the industrial communication device may be turned off.

At operation 1007, the industrial communication device may determine whether to execute the near field communication function. The industrial communication device may perform operation 1009 when the near field communication function is executed, or re-perform operation 1001 when the near field communication function is not executed.

At operation 1009, the industrial communication device may determine whether a second voice is inputted. The industrial communication device may perform operation 1011 when the second voice is inputted, or re-perform operation 1009 when the second voice is not inputted.

At operation 1011, the industrial communication device may transmit a signal corresponding to the second voice to an electronic device paired through near field communication.

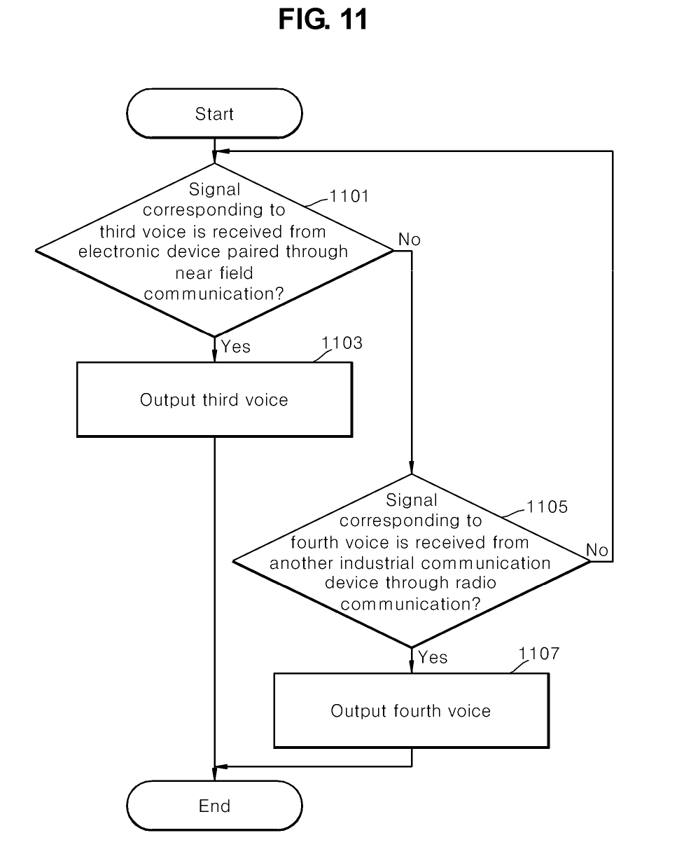

FIG. 11 is a flowchart illustrating an operation of an industrial communication device according to another embodiment of the present invention. Referring to FIG. 11, the industrial communication device may include an operation of outputting a third voice through a sound output unit of the industrial communication device when receiving a signal corresponding to the third voice from an electronic device through near field communication, and an operation of outputting a fourth voice through the sound output unit of the industrial communication device when receiving a signal corresponding to the fourth voice from another industrial communication device through radio communication.

At operation 1101, the industrial communication device may determine whether a signal corresponding to the third voice is received from an electronic device paired through near field communication. The industrial communication device may perform operation 1103 when the signal corresponding to the third voice is received from the electronic device paired through the near field communication, or perform operation 1105 when the signal corresponding to the third voice is not received.

At operation 1103, the industrial communication device may output the third voice.

At operation 1105, the industrial communication device may determine whether a signal corresponding to the fourth voice is received from another industrial communication device through radio communication. The industrial communication device may perform operation 1107 when the signal corresponding to the fourth voice is received from the another industrial communication device through radio communication, or re-perform operation 1101 when the signal corresponding to the fourth voice is not received.

At operation 1107, the industrial communication device may output the fourth voice.

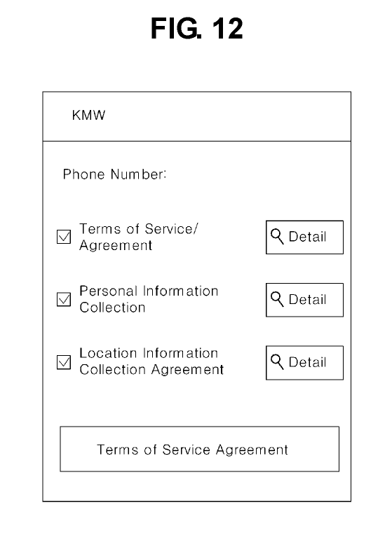

FIG. 12 illustrates a screen which is displayed when a user installs a messenger application and joins a messenger service according to an embodiment of the present invention. When the user joins the messenger service, a screen for the terms and conditions of the service and agreements on personal information collection and location information collection may be displayed on an electronic device as illustrated in FIG. 12.

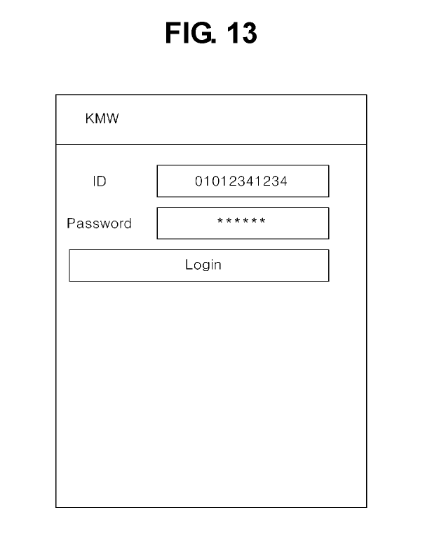

FIG. 13 illustrates a screen for login to the messenger application according to the embodiment of the present invention. When a user logs into the messenger application, the user may input an ID and password on the screen for inputting an ID and password as illustrated in FIG. 13.

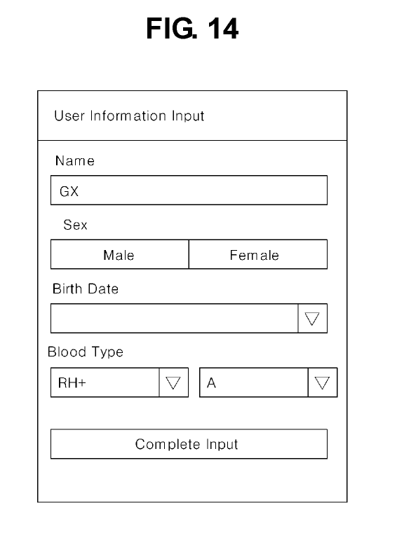

FIG. 14 illustrates a user information input screen of the messenger application according to the embodiment of the present invention. According to an embodiment, user information may be used as information which is transmitted to a control center or users belonging to the same channel, when the user of the messenger application meets an accident. The user may store his/her information by inputting and/or selecting the name, sex, birth date and blood type to and/or from the screen which is designed to receive a name, sex, birth date and blood type as illustrated in FIG. 14.

According to an embodiment, the user may select a user information modification menu on a designated setup screen, in order to modify the user information.

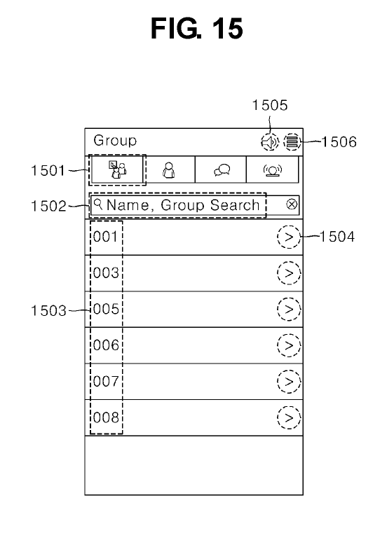

FIG. 15 illustrates a group screen of the messenger application according to the embodiment of the present invention. The group screen may display a list of conversation groups registered by a manager and including the user. Referring to FIG. 15, the group screen may include one or more of a group tab 1501 for displaying conversation groups to which the user belongs, a group search box 1502 for searching for a conversation group, a conversation group list 1503 including conversation groups registered in advance, a conversation window execution item 1504 for moving to the conversation window of the corresponding conversation group, a mute icon 1505 for muting a notification, call and voice conversation, and a group menu 1506. The group menu may be executed by selecting a group menu icon or selecting a menu button of the electronic device, and include one or more of list refresh, settings and program exit.

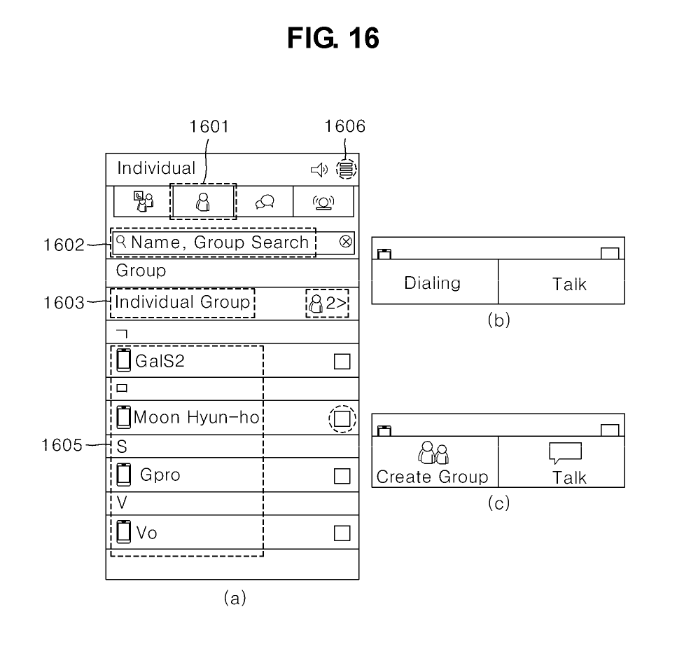

FIGS. 16(a) to 16(c) illustrate an individual screen of the messenger application and submenus of the individual screen according to the embodiment of the present invention. The individual screen may display users registered in the conversation groups, and display an item for executing an individual group conversation. The statuses of users registered in the conversation group may indicate whether the users have logged in or logged out. Referring to FIG. 16(a), the individual screen may include one or more of an individual tab 1601 for displaying individual users registered in a conversation group, an individual (individual conversation group) search box 1602 for searching for an individual conversation group and/or individual user, an individual conversation group item 1603 created as a conversation group of individual users by the user, a conversation window execution item 1604 for moving to a conversation window of the individual conversation group, individual user items 1605 registered in advance and indicating whether the corresponding users are on-line or off-line, an individual menu 1606 and an individual selection menu 1607. The individual conversation group item 1603 may include the number of users included in the additionally created individual conversation group. The individual menu 1606 may be executed by selecting an icon or selecting a menu button of the electronic device, and include one or more of list refresh, settings and program exit. When one user is selected from the individual user list 1605, the individual selection menu 1607 may display a dialing menu and talk menu as a submenu as illustrated in FIG. 16(b). Furthermore, when several users are selected from the individual user list 1605, the individual selection menu 1607 may display a create group menu and talk menu as a submenu as illustrated in FIG. 16(c).

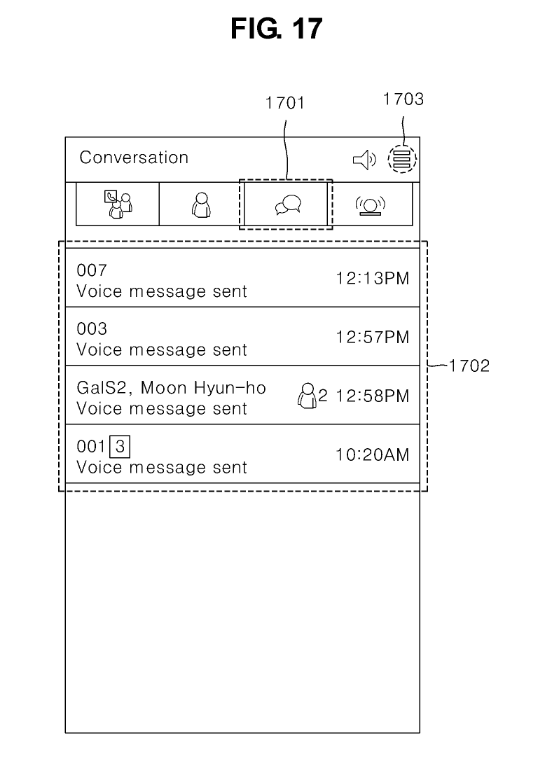

FIG. 17 illustrates a conversation list screen of the messenger application according to the embodiment of the present invention. Referring to FIG. 17, the conversation list screen may include one or more of a conversation list screen tab 1701, a conversation list 1702 and a conversation list menu 1703. The conversation list screen tab 1701 may be used to display the conversation list screen, and include the number of unread messages. The conversation list 1702 may display one or more of an individual conversation, an individual group conversation and a group conversation list. The conversation list 1702 may include conversation groups displayed from newest to oldest, and each of the conversation groups may display the time of the recently received message. The conversation list 1702 may indicate the number of unread messages. Furthermore, the conversation list 1702 may indicate the number of users in the case of an individual conversation or individual group conversation, and display one or more of voice transmission/reception, text contents and photograph. The conversation list menu may be executed by selecting an icon or selecting a menu button of the electronic device, and include one or more of list editing, settings and program exit. The list editing may include one or more of list deleting and move-to-screen.

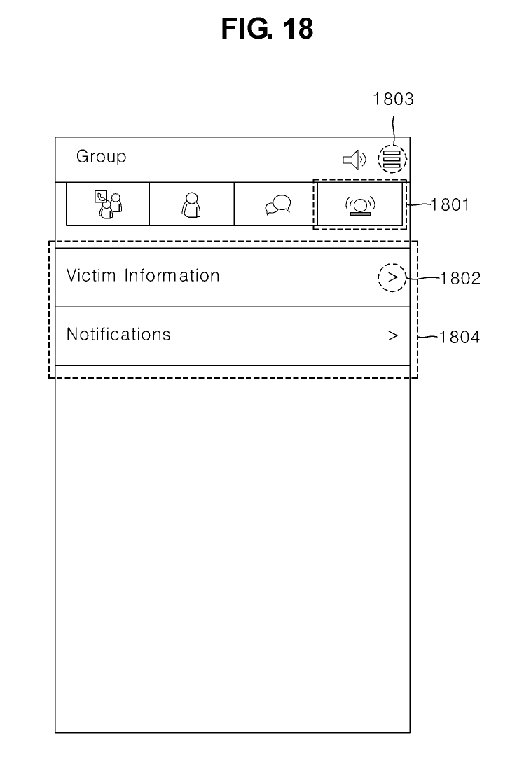

FIG. 18 illustrates an other-on screen of the messenger application according to the embodiment of the present invention. The other-on screen may display victim information and/or notifications. Referring to FIG. 18, the other-on screen may include one or more of an other-on screen tab 1801 for displaying the victim information and/or notifications, an accident information list execution item 1802 for displaying an accident information list, an other-on menu 1803 and an other-on item 1804. The other-on menu 1803 may include settings and/or exit, and the other-on item 1804 may include the accident information and/ore notifications.

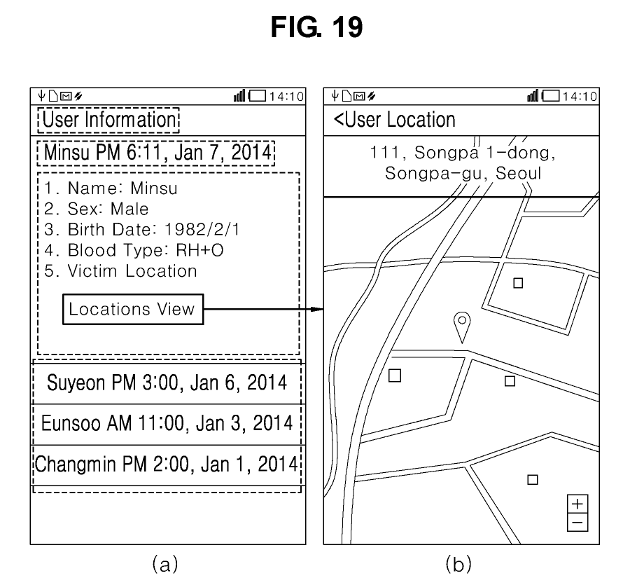

FIGS. 19(a) and 19(b) illustrate a victim information screen of the messenger application according to the embodiment of the present invention. The victim information screen may display a victim information list based on a message corresponding to a received accident alarm. Referring to FIG. 19(a), the victim information screen may include one or more of victim information navigation 1901, victim information list display 1902, victim information display 1903 and locations view 1904. The victim information navigation 1901 may have a function of moving to the previous screen. The victim information list display 1902 may display the victim name and/or accident date. The victim information display 1903 may display one or more of the name, sex, birth date and blood and victim location of the victim. The locations view 1904 may be selected according to a user manipulation, and display the victim location on a map as illustrated in FIG. 19(b).

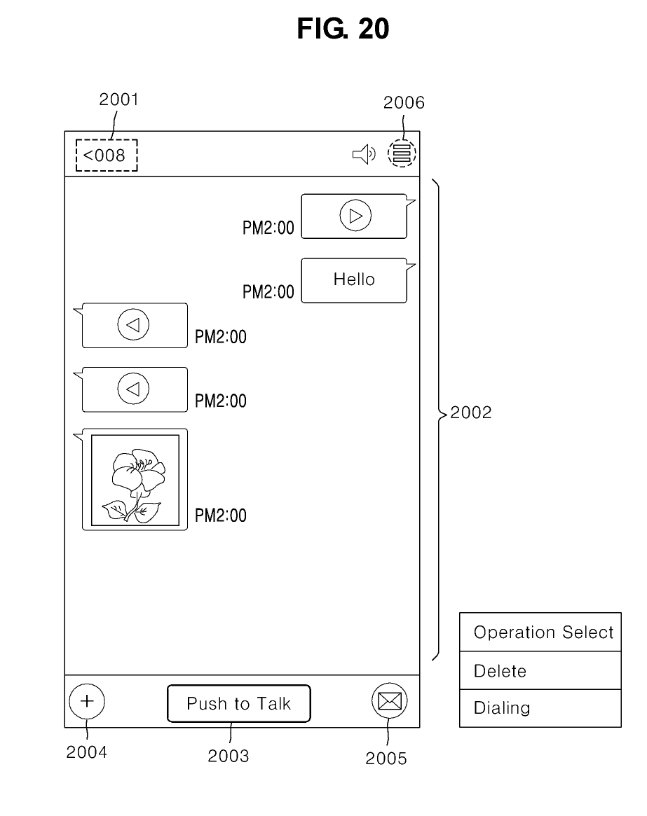

FIG. 20 illustrates a conversation window screen of a conversation group of the messenger application according to the embodiment of the present invention. Messages such as voices, texts and photographs in a group or individual conversation through the conversation window may be stored in the electronic device. Referring to FIG. 20, the conversation window may include a conversation window navigation 2001, a conversation window message display 2002, a PTT transmission button 2003, an other-on transmission button 2004, a text transmission icon 2005 and a conversation window menu 2006. The conversation window navigation 2001 may have a function to moving to the previous screen. The conversation window message display 2002 may display voice, text, photograph and/or video communications, and display a confirmation count of a contact. The PTT transmission button 2003 is a “push-to-talk” button. When a user talks with the push-to-talk button pressed, a voice of the user may be transmitted. The other-on transmission button 2004 may include call, photographing, filming, photograph selection and/or video selection. The text transmission icon 2005 may be used when transmitting a text message. The conversation window menu 2006 may include conversation participant view, conversation contents delete, settings and/or exit. In addition, when the users touches and long-presses a message displayed on the conversation window, an individual message delete item and a dialing item for the corresponding contact of the message may be displayed.

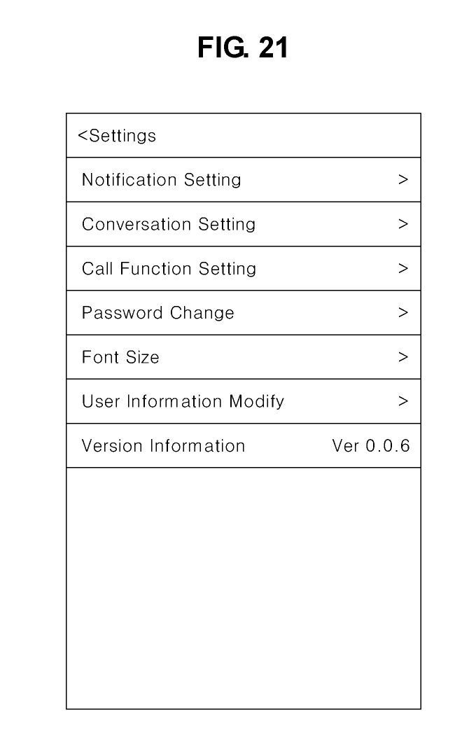

FIG. 21 illustrates an option setting screen of the messenger application according to the embodiment of the present invention. Referring to FIG. 21, the option setting screen may include one or more of notification setting, conversation setting, call function setting, password change, font size setting, user information modification and version information.

The notification setting may include a notification sound setting item for setting a sound, vibration and ring-back tone and an another conversation window radio hearing item for allowing a user to hear a voice of a contact included in another conversation window through radio communication while a specific conversation window is executed.

The conversation setting may include a volume-key radio communication item for performing radio communication through the DOWN key of the electronic device, a radio key sound item for setting a radio-key transmission sound, and a sending end vibration item for vibrating the electronic device to information the user that sending is ended. The call function setting may be used to set a notification period (for example, 30 to 60 seconds) and a notification frequency (for example, once to five minutes) when a call is received.

The password change may be used to change a password, the font size setting may be used to change a font size to small, intermediate and large sizes, and the version information may display the version information of the current messenger application.

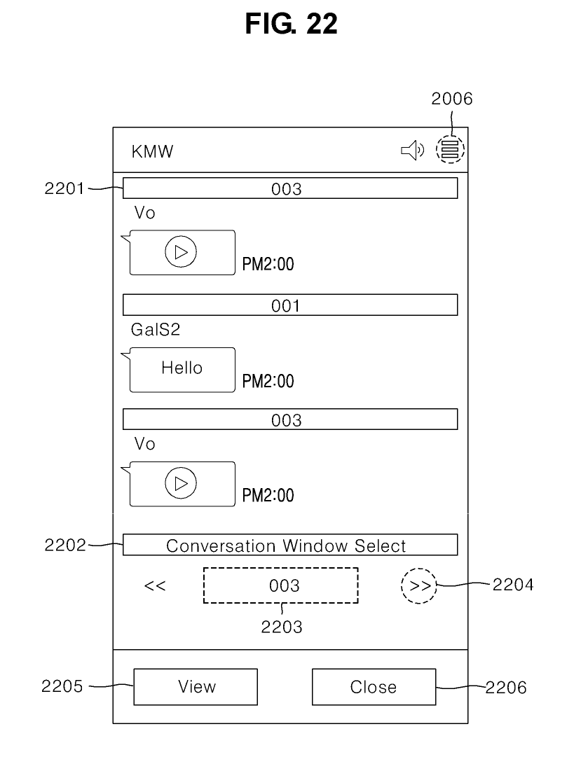

FIG. 22 illustrates a screen on which a conversation window of a conversation group of the messenger application according to the embodiment of the present invention is displayed as a pop-up window. According to an embodiment, when channel and individual messages are received while the screen of the electronic device is turned off, the user may have a conversation with a contact on the pop-up window. The screen on which the conversation window is displayed as a pop-up window may include one or more of a group name or individual conversation window name 2201, a conversation window selection item 2202, an activated conversation window display 2203, a move-to-conversation-window menu 2204, a move-to-messenger-application menu 2205 and a close menu 2206 for closing the corresponding pop-up window.

In the group name or individual conversation window name 2201, the group name may be displayed when a message is received through the corresponding group, and the individual name may be displayed when a message is received from an individual user. The conversation window selection item 2202 may indicate the number of currently created groups. In the activated conversation window display 2203, the user can press the volume down key to transmit a voice on the current pop-up window, and continuously maintain the conversation through the currently activated conversation window even when a message is received through another conversation window. The move-to-conversation-window menu 2204 may have a function of moving to another conversation window of the conversation list such that the user can have a conversation with a contact on the conversation window.

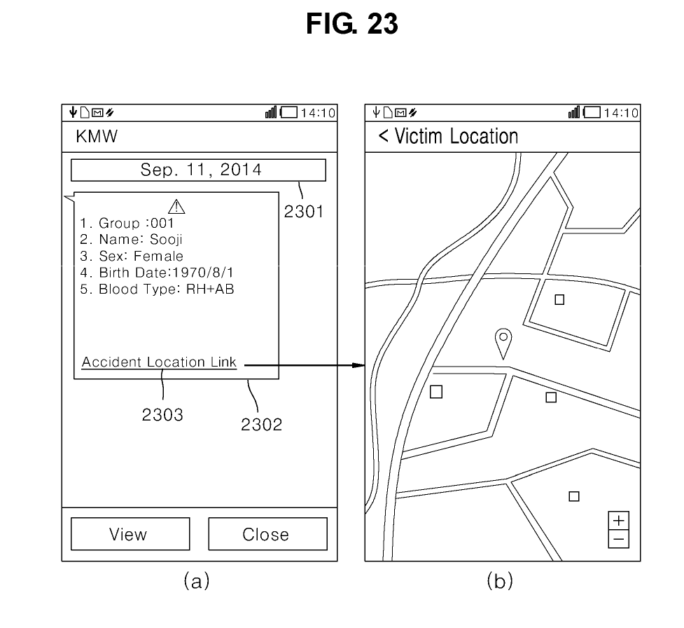

FIGS. 23(a) and 23(b) illustrate screens on which victim information of the messenger application according to the embodiment of the present invention is displayed as a pop-up window. According to an embodiment, when a message corresponding to an accident alarm is received while the screen of the electronic device is turned off, victim information may be displayed as a pop-up window. Referring to FIG. 23(a), the screen on which the victim information is displayed as a pop-up window may include a victim information creation date 2301 (for example, the year, month and day), a victim information list 2302, a victim location link 2303, a view menu 2304 and a close menu 2305.

The victim information list 2302 may display the group, name, sex, birth date and blood type of the victim. When the victim location link 2303 is selected by the user, a victim location may be displayed on the screen as illustrated in FIG. 23(b). When the view menu 2304 is selected, the victim information screen may be displayed as illustrated in FIG. 19. When the close menu 2305 is selected, the window may be closed.

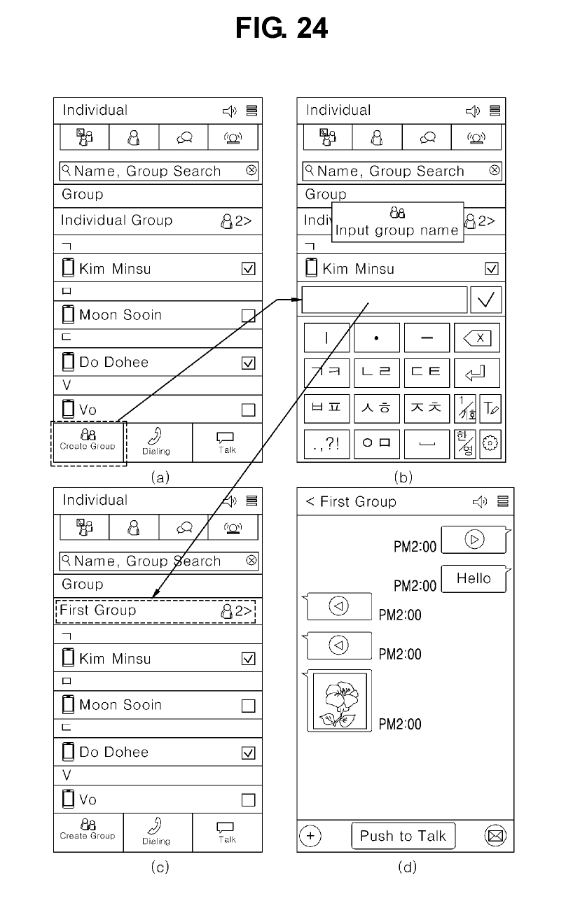

FIGS. 24(a) to 24(d) illustrate screens for describing a process of creating an individual conversation group of the messenger application according to the embodiment of the present invention. During the individual conversation group creation process, a user can select a contact on the individual screen, and set an individual conversation group name, thereby creating the individual conversation group. Then, the user can select the created individual conversation group to have a multi-party conversation. According to an embodiment, when the create group menu at the bottom of the individual screen is selected by the user as illustrated in FIG. 24(a), the electronic device may display an individual conversation group name setting screen as illustrated in FIG. 24(b). For example, when the individual conversation group name is set to a first group according to a user input, the electronic device may display the created individual conversation group on the screen as illustrated in FIG. 24(c). Furthermore, when an execution of the first group is selected according to a user input, the electronic device may display a conversation window of the individual conversation group on the screen as illustrated in FIG. 24(d).

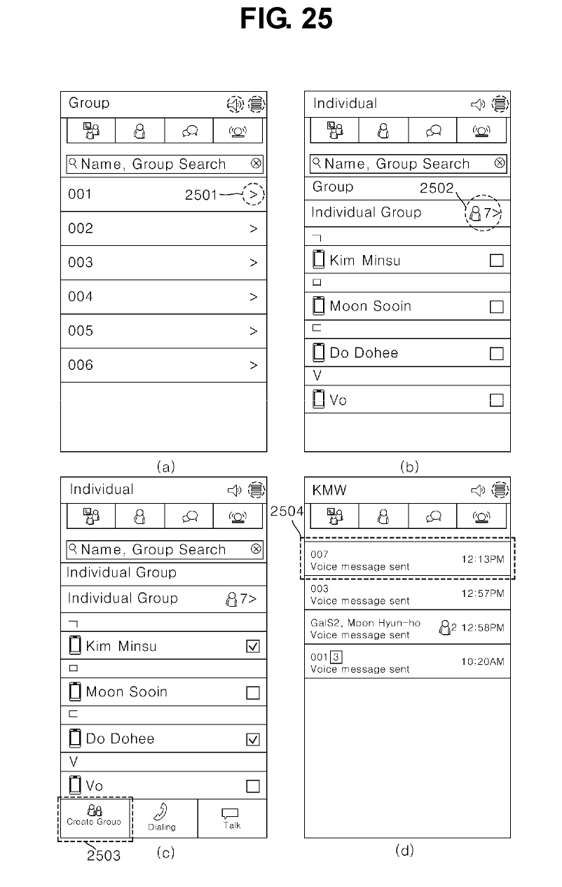

FIGS. 25(a) to 25(d) illustrate screens for describing a process of activating a conversation window of a conversation group of the messenger application according to the embodiment of the present invention. Referring to FIG. 25(a), the user may execute a conversation window by selecting a conversation window execution item 2501 of a group in which the user wants to participate, on the group screen. Referring to FIG. 25(b), the user may execute a conversation window by selecting a conversation window execution item 2502 of an individual group conversation list in which the user wants to participate, on the individual screen. Referring to FIG. 25(c), the user may select one or more contacts on the individual screen, and then select a talk menu 2503 at the bottom of the screen in order to execute a conversation window. Referring to FIG. 25(d), the user may execute a conversation window by selecting a conversation list 2504 on the group screen on which conversation lists are displayed.

According to an embodiment, even while the screen of the electronic device is turned off, a conversation with a contact included in a conversation group of the messenger application can be maintained. For example, when the screen of the electronic device is turned off while the conversation window is displayed, a conversation with a contact or contacts included in a conversation window which has been displayed can be maintained. Furthermore, when the screen of the electronic device is turned off while a conversation window is not displayed, a conversation with a contact or contacts of a designated conversation group can be maintained.

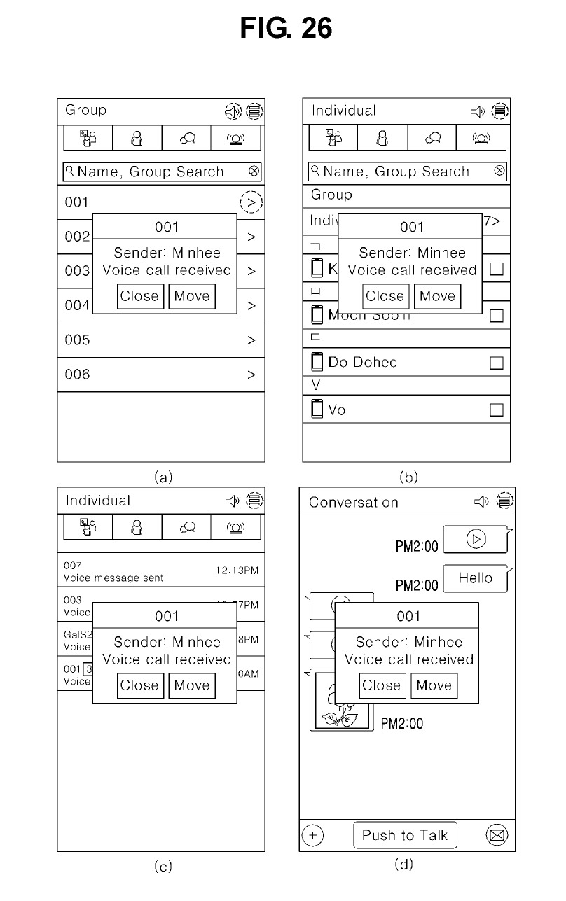

FIGS. 26(a) to 26(d) illustrate screens for describing a process of moving to a conversation window of a conversation group of the messenger application according to the embodiment of the present invention. According to an embodiment, when a radio message (for example, text, photograph, video and voice) is received through another conversation window, the electronic device may display a pop-up window for notifying the radio message on the screen, and the pop-up window may be displayed for a predetermined time (for example, five seconds). For example, when a voice message is received while the group screen is executed as illustrated in FIG. 26(a), the individual screen is executed as illustrated in FIG. 26(b), a conversation list is executed as illustrated in FIG. 26(c), or a specific conversation window is activated as illustrated in FIG. 26(d), the electronic device may display a pop-up window including sender information (group information and name information) on the screen. When a move menu is selected on the displayed pop-up window by the user, the electronic device may move the conversation window to the corresponding group of the sender.

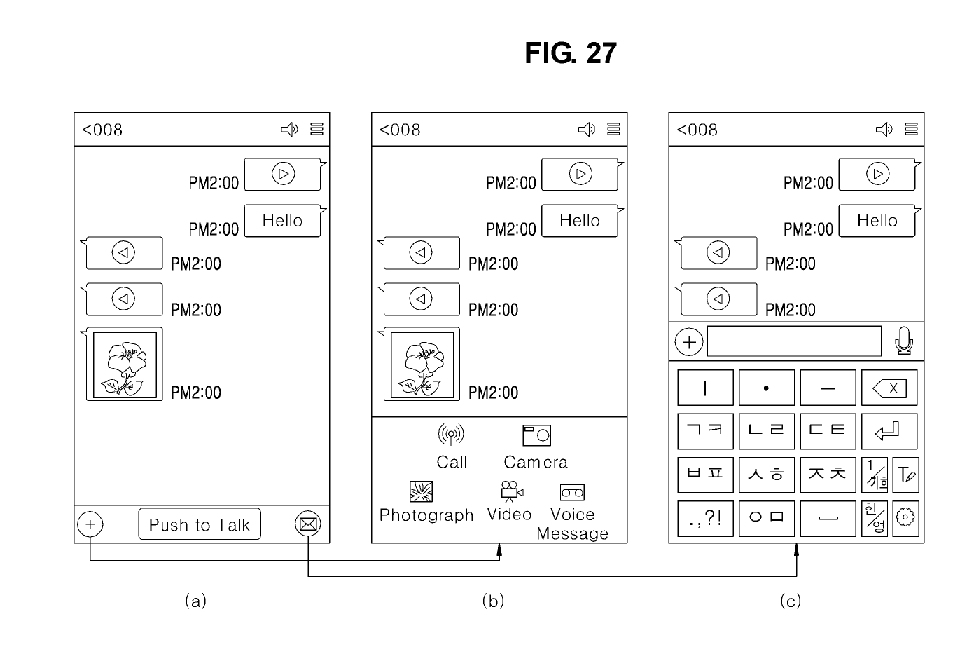

FIGS. 27(a) to 27(c) illustrate screens for describing a conversation on a conversation window of a conversation group of the messenger application according to the embodiment of the present invention. According to an embodiment, the electronic device may transmit or receive a voice, text, photograph or video through a conversation window according to a user manipulation. For example, when + menu 2701 is selected on a conversation window illustrated in FIG. 27(a) according to a user manipulation, the electronic device may display a call menu for transmitting a call signal, a camera menu for taking a photograph, a photograph menu for transmitting a photograph, a video menu for transmitting a video, and a voice message menu for transmitting a voice message, on the screen as illustrated in FIG. 27(b). Furthermore, when a message menu 2702 is selected on the conversation window illustrated in FIG. 27(a) according to a user manipulation, the electronic device may display a screen for inputting a message as illustrated in FIG. 27(c).

According to an additional embodiment, the user may set a function for hearing a voice of another conversation window in the basic setting menu. Such a function allows the user of the electronic device to hear a voice from another conversation window even when the voice is received on the current conversation window screen.

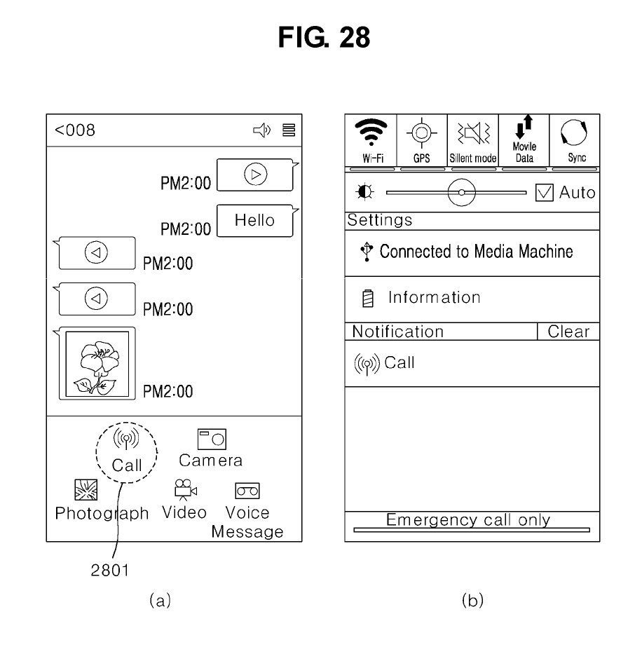

FIGS. 28(a) to 28(b) illustrate screens for describing a call function on a conversation window of the messenger application according to the embodiment of the present invention. When a call menu 2801 is selected on a conversation window displayed as illustrated in FIG. 28(a), a call notification may be displayed on a notification window screen of the electronic device of a contact included in the conversation window as illustrated in FIG. 28(b). Furthermore, although not illustrated, the corresponding call notification may be displayed on the conversation window screen of the electronic device of the contact.

The embodiments of the present invention can be implemented in hardware, software or a combination of hardware and software. The software can be stored in a nonvolatile storage device such as a ROM, a memory such as a RAM, memory chip or integrated circuit, or a storage medium such as a CD, DVD, magnetic disk or magnetic tape which can be optically written and read through a machine (for example, computer), regardless of whether the software can be deleted or rewritten. A memory which can be included in a portable terminal may correspond to an example of a storage medium which can be read through a machine suitable for storing a program or programs including commands for implementing the embodiments of the present invention. Therefore, the present invention may include a program containing codes for implementing a device or method described in an arbitrary claim of this specification and a storage medium which can be read through a machine for storing the program. Such a program can be electronically transferred through an arbitrary medium such as a communication signal transferred through wired or wireless connection, and the present invention may include equivalents to the program.

What is claimed is:

1. An electronic device for controlling an industrial communication device, comprising:
a near field communication module;
a main communication module; and
a control unit configured to confirm one or more contacts connected to a conversation group of a messenger application when a voice signal corresponding to a first voice is received from an industrial communication device paired through the near field communication module, and transmit a voice message corresponding to the first voice to the corresponding device or devices of the confirmed contact or contacts using the main communication module.

2. The electronic device of claim 1, further comprising a display unit configured to display a conversation window of the conversation group,
wherein when receiving the voice signal corresponding to the first voice from the industrial communication device paired through the near field communication module, the control unit controls the display unit to display a visual effect corresponding to the first voice.

3. The electronic device of claim 1, further comprising a storage unit,
wherein when receiving a signal corresponding to the first voice from the industrial communication device paired through the near field communication module, the control unit controls the storage unit to store voice data corresponding to the first voice.

4. The electronic device of claim 1, wherein when receiving a voice message corresponding to a second voice from the corresponding device through the main communication module, the control unit controls the near field communication module to transmit a voice signal corresponding to the second voice to the industrial communication device.

5. The electronic device of claim 4, further comprising a display unit,
wherein when receiving the voice message corresponding to the second voice from the corresponding device through the main communication module, the control unit controls the display unit to display a visual effect corresponding to the second voice.

6. The electronic device of claim 4, further comprising a storage unit,
wherein when receiving the voice message corresponding to the second voice from the corresponding device through the main communication module, the control unit controls the storage unit to store voice data corresponding to the second voice.

7. The electronic device of claim 1, wherein when receiving a signal corresponding to a first accident alarm from the industrial communication device paired through the near field communication module, the control unit controls the main communication module to transmit a message corresponding to the first accident alarm to the corresponding device or devices of one or more contacts connected to the messenger application.

8. The electronic device of claim 7, further comprising a display unit,
wherein when receiving a message corresponding to a second accident alarm from the corresponding device through the main communication module, the control unit controls the near field communication module to transmit a signal corresponding to the second accident alarm to the industrial communication device, and controls the display unit to display information corresponding to the second accident alarm.

9. The electronic device of claim 8, wherein the message corresponding to the first accident alarm and the message corresponding to the second accident alarm comprise one or more of an accident date, information of an accident victim and an accident location.

10. An industrial communication device comprising:
a near field communication module;
a radio communication module configured to communicate FRS (Family Radio Service) signals;
a voice input unit;
an input module; and
a control unit configured to decide whether to execute a radio communication function or near field communication function, according to a user manipulation inputted through the input module, and transmit a voice signal corresponding to a first voice to the outside through the radio communication module when the first voice is inputted through the voice input unit after the execution of the radio communication function was decided, or transmit a voice signal corresponding to a second voice to an electronic device paired through the near field communication module when the second voice is inputted through the voice input unit after the execution of the near field communication function was decided.

11. The industrial communication device of claim 10, further comprising a lighting unit,
wherein the control unit turns on a first lighting included in the lighting unit when the execution of the radio communication function is decided, or turns on a second lighting included in the lighting unit when the execution of the near field communication function is decided.

12. The industrial communication device of claim 10, further comprising a sound output unit,
wherein the control unit outputs a third voice through the sound output unit when receiving a signal corresponding to the third voice from the electronic device paired through the near field communication module, and output a fourth voice through the sound output unit when receiving a signal corresponding to the fourth voice from another industrial communication device through the radio communication module.

13. The industrial communication device of claim 10, wherein according to a user manipulation inputted through the input module, the control unit transmits a signal to the electronic device through the near field communication module, the signal serving to activate another conversation group instead of a currently activated conversation group among conversation groups of the messenger application of the electronic device.

14. The industrial communication device of claim 10, wherein according to a user manipulation inputted through the input module, the control unit changes a radio channel set in the radio communication module to any one radio channel among designated radio channels.
